(19) United States
(12) Patent Application Publication
(10) Pub. No.: US 2001/0055075 A1
(43) Pub. Date: Dec. 27, 2001

(54) Liquid crystal display and rotating device of the same

(76) Inventors: Shih-Hsuan Wang, Taipei (TW); Yi-Chan Cheng, Taipei (TW)

Correspondence Address: SAWYER LAW GROUP LLP, Suite 406, Embarcadero Corporate Center, 2465 East Bayshore Road, Palo Alto, CA, 94303, US

(21) Appl. No.: 09/884,513

(22) Filed: Jun. 19, 2001

(30) Foreign Application Priority Data
Jun. 22, 2000 (TW) 89210728

(51) Int. Cl. G02F 1/1333

(52) U.S. Cl. 349/58

(57) ABSTRACT

A liquid crystal display and a rotating device thereof are proposed. A liquid crystal screen of the liquid crystal display is supported by a stand and can be rotated clockwise and counterclockwise with the use of the rotating device being connected to a back side of the screen. In application of a positioning portion of the rotating device in cooperation with positioning holes formed at the back side of the screen, the screen can be maintained in position by the engagement between the positioning portion and the positioning holes, or can be rotated by separating the positioning portion from the positioning holes, in a manner that the screen is prevented from colliding a base of the stand.

### FIELD OF THE INVENTION

The present invention relates to liquid crystal display (LCD) monitors and rotating devices thereof, and more particularly, to a LCD monitor and a rotating device thereof having a low visual angle, low gravity center, preferred integrity, a simple structure and easiness in operation.

### BACKGROUND OF THE INVENTION

A conventional LCD monitor, illustrated in FIGS. 1 and 2, includes a liquid crystal screen 1, a stand 2 and a rotating device 3 by which the screen 1 is connected to the stand 2 in a manner that the screen 1 can freely rotates on a plane where the screen is located. Thereby, the screen 1 can be disposed transversely as illustrated in FIG. 1 or longitudinally as illustrated in FIG. 3 for being rotated by 90 degrees, so as to adjust the position of the screen 1. As such, the screen 1 is disposed on the stand 2 apart from a base of the stand 2 in a fixed height sufficient to prevent the screen 1 from colliding with the base of the stand 2 as the screen 1 rotates from the transversal position to the longitudinal position.

However, such arrangement for the stand 2 with the fixed height thereof may be disadvantageous for human health for leading to a high visual angel for eyes when viewing the screen 1. Accordingly, the gravity center of the LCD monitor is raised in position, which makes the monitor easy to tilt and affects the appearance of the monitor.

In order to solve the foregoing defects, a LCD monitor is proposed as illustrated in FIGS. 4 and 5. The LCD monitor applies a movable structure 4, which is a portion of a stand 2′ to be connected with a liquid crystal screen 1 as shown in FIG. 5, allowing a user to adjust the height of the movable structure 4 for providing lower gravity center and a low visual angle when viewing the screen 1. Therefore, for rotating the screen 1 from transverse to longitudinal position or from longitudinal to transverse position, the movable structure 4 can be raised or lowered in height respectively by using a positioning device 5, so as to prevent the screen 1 from colliding the base of the stand 2′. As such, the screen 1 can be usually retained in a lower height, allowing a lower visual angle, lower gravity center, and a preferred integrity thereof to be achieved.

However, the screen 1 can be adjusted in height by applying the movable structure 4 and the positioning device 5 of the stand 2′, but for frequently rotating the screen 1, it is complicated in operation for the need of adjusting the screen 1 for each rotation. Furthermore, production of the movable structure 4 increases complexity in manufacturing, so that the manufacture cost is hardly lowered.

### SUMMARY OF THE INVENTION

The primary objective of the present invention is to provide a liquid crystal display and a rotating device thereof, which allow a screen thereof to be maintained in a position possibly closest to a base of a stand for achieving a low visual angle, low gravity center, preferred integrity, a simple structure and easiness in operation.

In accordance with the above and other objectives, the present invention provides a liquid crystal display and a rotating device thereof comprising:

a liquid crystal screen;

a stand for supporting the liquid crystal screen; and

a rotating device connected to the stand and a back surface of the liquid crystal screen at an intersection point formed by an angle dividing line at a lower right or left corner of the screen and a line of an angle of 45 or 135 degrees elevated from a geometric center of the screen, for allowing the liquid crystal screen to be rotated upwardly or downwardly and to be rotated freely on a plane parallel to a plane of the liquid crystal screen.

In addition, the rotating device further comprises at least a positioning portion. As the liquid crystal screen is in a vertical position, the positioning portion is usually engaged with a positioning hole formed on the back surface of the liquid crystal screen. As such, a user needs to rotate the liquid crystal screen upwardly for separating the positioning portion from the positioning hole, allowing the liquid crystal screen to be rotated freely on the plane parallel to the plane of the liquid crystal screen.

The various objectives and advantages of the present invention will be more readily understood from the following detailed description when read in conjunction with the appended drawing.

### BRIEF DESCRIPTION OF THE DRAWINGS

FIG. 1 is a front view of a conventional liquid crystal display;

FIG. 2 is a lateral view of the liquid crystal display of FIG. 1;

FIG. 3 is a front view showing the liquid crystal display of FIG. 1 being in a longitudinal position;

FIG. 4 is a front view of another conventional liquid crystal display;

FIG. 5 is a lateral view of the liquid crystal display of FIG. 4;

FIG. 6 is a front view of the embodiment in the present invention;

FIG. 7 is a right lateral view of the embodiment in the present invention of FIG. 6;

FIG. 8 is a schematic perspective view of the rotating device of the embodiment in the present invention of FIG. 6;

FIG. 9 is a front view showing the liquid crystal screen of the embodiment in the present invention of FIG. 6 being in a longitudinal position;

FIG. 10 is a schematic view showing the rotating device of FIG. 8 being placed on the stand;

FIG. 11 is a left side view of the embodiment in the present invention of FIG. 6;

FIG. 12 is a schematic view showing the liquid crystal screen of FIG. 11 being rotated upwardly so as to completely separate the positioning portion from being engaged with the positioning holes;

FIG. 13 is a schematic view showing the positions of the rotating point and the positioning holes on the back surface of the liquid crystal screen of FIG. 6; and

FIG. 14 is a schematic view showing the positions of another rotating point for fixing the rotating device thereon and the corresponding positioning holes on the back surface of the screen.

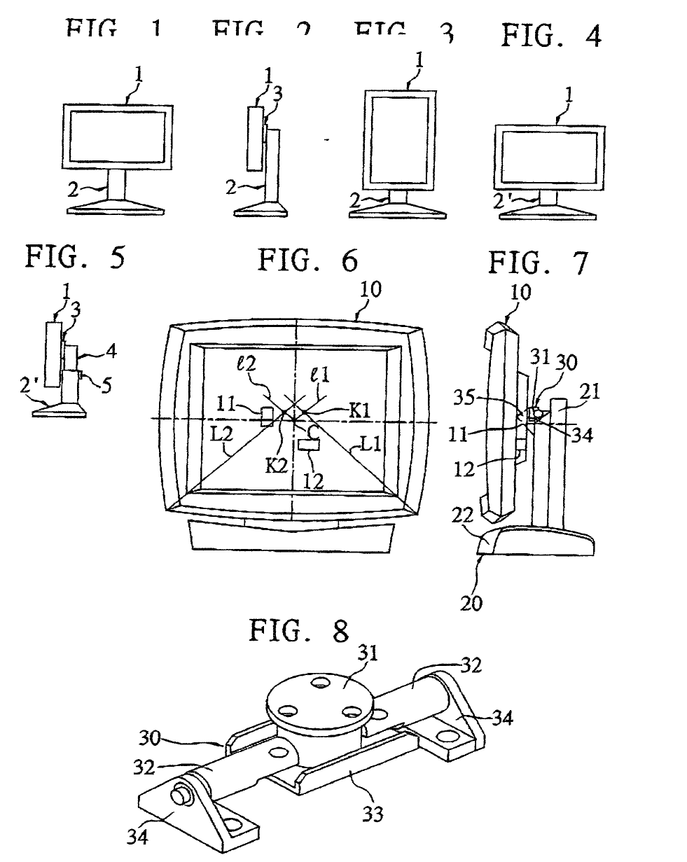

### DETAILED DESCRIPTION

Referring to FIGS. 6 and 7, the preferred embodiment of the present invention is illustrated, comprising a liquid crystal screen 10, a stand 20 for supporting the screen 10, and a rotating device 30 connected to a back side of the screen 10 and to an upwardly extending portion 21 of the stand 20. The rotating device 30 is constructed as illustrated in FIG. 8, comprising a rotating plate 3 1 fixed to the back side of the screen 10, rotating shafts 32 formed at two sides of the rotating plate 31, a bottom plate 33 for jointing the rotating plate 31 and the rotating shafts 32, and fixing legs 34 connected to ends of the rotary shafts 32. As such, the rotating plate 31, the rotating shafts 32 and the bottom plate 33 are integrally formed as to be freely rotated on the fixing legs 34.

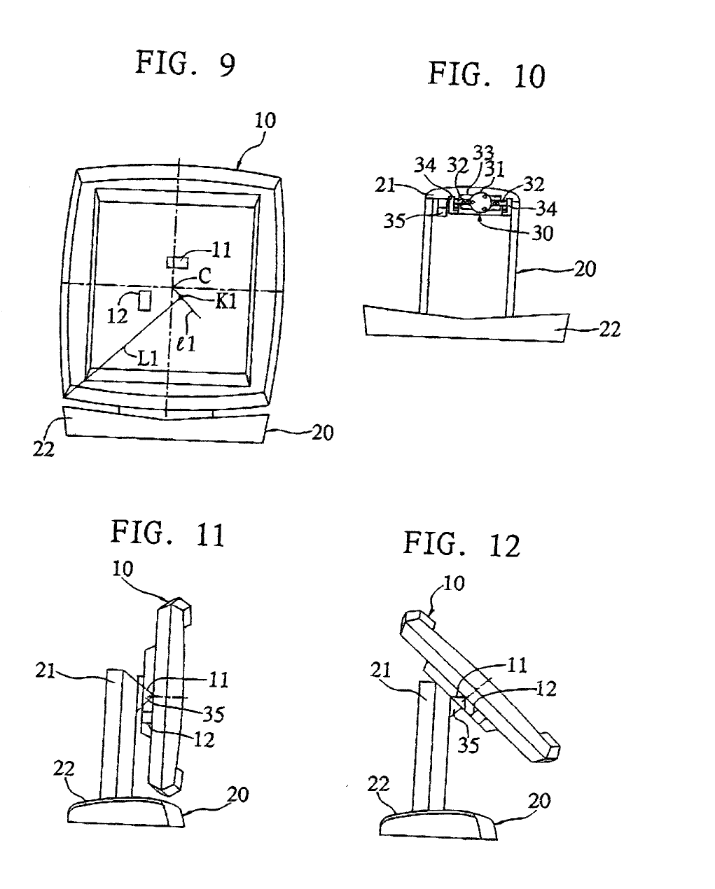

With reference to FIGS. 6 and 7, the rotating plate 31 of the rotating device 30 is connected to the back surface of the screen 10 at an intersection point K1 formed by an angle dividing line L1 at a lower right corner of a plane of the screen 10 and a line of an angle of 45 degrees elevated from a geometrical center C of the plane of the screen 10. That is, the screen 10 is eccentrically mounted on the extending portion 21 of the stand 20 by means of the rotating plate 30. As a result, as the screen 10 is rotated clockwise by 90 degrees from the transverse position of FIG. 6 to the longitudinal position of FIG. 9, the lower right corner of the screen 10 hardly contact a base 22 of the stand 20, and therefore the K1 point is lowered in position.

In order to prevent the lower right corner of the screen 10 from colliding with the base 22 of the stand 20 during rotation, a positioning portion 35 is formed at a leftward position on the extending portion 21 of the stand 20, as shown in FIG. 10. As the screen 10 is vertically arranged in the transversal positions illustrated in FIGS. 7 and 11, the positioning portion 35 is usually engaged with a positioning hole 11 at the back side of the screen 10. As such, the screen 10 can be rotated to a preferred position on a plane parallel to the plane of the screen 10 in a manner that the rotating shafts 32 of the rotating device 30 are rotated with respect to the fixing legs 34, allowing the screen 10 to be rotated upwardly until the positioning portion 35 is completely separated from the positioning hole 11, as illustrated in FIG. 12. After the screen 10 is rotated to the preferred position e.g. by 90 degrees clockwise, the screen 10 can be rotated downwardly to a vertically-arranged longitudinal position as shown in FIG. 9. At the mean time, the positioning portion 35 is engaged with another positioning hole 12 at the back side of the screen 10, allowing the screen 10 to be in position for preventing the collision with the base 22 of the stand 20 from occurrence due to a careless rotation.

Similarly, if a user prefers to rotate the screen 10 from the longitudinal position of FIG. 9 counterclockwise to the transversal position of FIG. 6, first, the screen 10 is rotated upwardly for the positioning portion 35 being separated from the positioning hole 12. Then, the screen 10 is counterclockwise rotated by 90 degrees on the plane parallel to the plane of the screen 10. Next, the screen 10 is rotated to the vertical position, allowing the positioning portion 35 to be engaged with the positioning hole 11. As such, the screen 10 can be repositioned in the transversal position illustrated in FIG. 6.

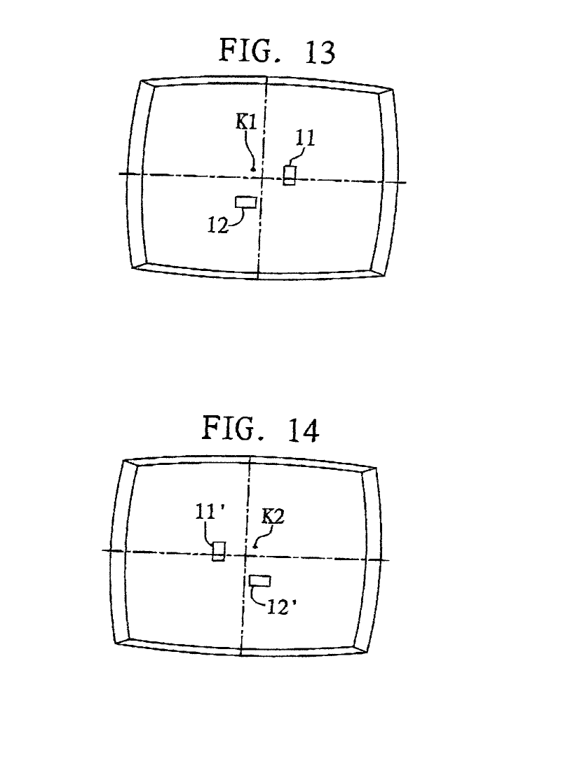

FIG. 13 is a schematic showing the positions of the point K1 and the positioning holes 11, 12 on the back side of the liquid crystal screen 10 of FIG. 6.

As concluded from the above-mentioned, with the use of the rotating device 30 being eccentrically mounted on the point K1 in present invention, the lower right corner of the screen 10 hardly contact the base 22 of the stand 20, and the height of the point K1 is reduced, so that the gravity center of the liquid crystal display of the invention is lowered in position, regardless of the clockwise rotation from the transverse position of FIG. 6 to the longitudinal position of FIG. 9 or the counterclockwise rotation from a longitudinal position of FIG. 9 to the transversal position of FIG. 6.

On the extending portion 21 of the stand 20 and the back side of the screen 10 there are installed the positioning portion 35 and the positioning holes 11, 12 correspondingly, allowing the screen 10 to be rotated on a tilted plane. As a result, the point K1 and accordingly the gravity center of the liquid crystal display of the invention are further lowered in position, so that a low visual angle is achieved and the integrity of the liquid crystal display in appearance is improved.

Besides, with the use of the positioning portion 35 in cooperation with the positioning holes 11, 12, the screen 10 in a vertical condition of the transversal position or the longitudinal position is positioned as the positioning portion 35 being engaged with the positioning holes 11, 12 respectively. As such, for rotating the screen 10 clockwise or counterclockwise, the screen 10 must be rotated upwardly for separating the positioning portion 35 from the positioning holes 11, 12. Therefore, the screen 10 can be prevented from colliding with the stand 20.

Moreover, in order to avoid the complexity for manufacturing the movable structure 4 in the prior art illustrated in FIG. 5, the present invention provides a simplified structure and easiness in operation without the need of adjusting the height of the stand.

The present invention has been described using exemplary preferred embodiments. However, it is to be understood that the scope of the invention is not limited to the disclosed embodiments. On the contrary, it is intended to cover various modifications and similar arrangements. For example, the rotating device 30 can be connected to the back side of the screen 10 at an intersection point K2 formed by an angle dividing line L2 at the lower left corner of the screen 10 and a line □2 of an angle of 135 degrees elevated from the geometric center C of the screen 10, as shown in FIG. 6. A positioning portion and positioning holes are formed at mirror-symmetrical positions with respect to the positioning portion 35 and the positioning holes 11, 12 (positions of the point K2 and positioning holes 11′, 12′ are illustrated in FIG. 14, besides, the positioning portion is formed in a rightward position on the extending portion 21 of the stand 20). Furthermore, a rotating device other than the rotating device 30 illustrated in FIG. 8 can be used, as long as it allows the screen 10 to be rotated upwardly or downwardly and on a plane parallel to the plane of the screen 10. The scope of the claims, therefore, should be accorded the broadest interpretation so as to encompass all such modifications and similar arrangements.

What is claimed is:

1. A liquid crystal display comprising:
a liquid crystal screen;
a stand for supporting the liquid crystal screen;
a rotating device connected to the stand and a back side of the liquid crystal screen, for allowing the liquid crystal screen to be freely rotated upwardly or downwardly and to be rotated freely on a plane parallel to a plane of the screen; and
a positioning device mounted on the stand and the back side of the liquid crystal screen, for allowing the screen to be rotated by tilting the screen.

2. The liquid crystal display of claim 1, wherein the positioning device comprises: a positioning portion mounted at the stand; and a positioning hole formed on the back side of the liquid crystal screen, for allowing the positioning portion to be engaged with the positioning hole as the screen is in a predetermined condition; for rotating the screen, the positioning portion is separated from the positioning hole by tilting the screen.

3. The liquid crystal display of claim 1, wherein the positioning device comprises a positioning hole formed at the stand; and a positioning portion mounted on the back side of the liquid crystal screen, for being engaged with the positioning hole as the screen is in a predetermined condition, for rotating the screen, the positioning portion is separated from the positioning hole by tilting the screen.

4. The liquid crystal display of claim 1, wherein the rotating device is connected to the stand and the back side of the liquid crystal screen at an intersection point formed by an angle dividing line at a lower right corner of the plane of the screen and a line of an angle of 45 degrees elevated from a geometric center of the screen.

5. The liquid crystal display of claim 1, wherein the rotating device is connected to the stand and the back side of the liquid crystal screen at an intersection point formed by an angle dividing line at a lower left corner of the plane of the screen and a line of an angle of 135 degrees elevated from a geometrical center of the screen.

6. The liquid crystal display of claim 2, wherein the rotating device is connected to the stand and the back side of the liquid crystal screen at an intersection point formed by an angle dividing line at a lower right corner of the plane of the screen and a line of an angle of 45 degrees elevated from a geometric center of the screen.

7. The liquid crystal display of claim 2, wherein the rotating device is connected to the stand and the back side of the liquid crystal screen at an intersection point formed by an angle dividing line at a lower left corner of the plane of the screen and a line of an angle of 135 degrees elevated from a geometrical center of the screen.

8. The liquid crystal display of claim 3, wherein the rotating device is connected to the stand and the back side of the liquid crystal screen at an intersection point formed by an angle dividing line at a lower right corner of the plane of the screen and a line of an angle of 45 degrees elevated from a geometric center of the screen.

9. The liquid crystal display of claim 3, wherein the rotating device is connected to the stand and the back side of the liquid crystal screen at an intersection point formed by an angle dividing line at a lower left corner of the plane of the screen and a line of an angle of 135 degrees elevated from a geometrical center of the screen.

10. A liquid crystal display comprising:
a liquid crystal screen;
a stand for supporting the liquid crystal screen;
a rotating device connected to the stand and a back side of the liquid crystal screen at an intersection point formed by an angle dividing line at a lower right corner of a plane of the screen and a line of an angle of 45 degrees elevated from a geometrical center of the screen, for allowing the screen to be freely rotated upwardly or downwardly and to be rotated freely on a plane parallel to the plane of the screen.

11. The liquid crystal display of claim 10, further comprising a positioning device, which includes a positioning hole installed at the stand; and a positioning portion formed on the back side of the liquid crystal screen, for being engaged with the positioning hole as the screen is in a predetermined condition, for rotating the screen, the positioning portion is separated from the positioning hole by tilting the screen.

12. A liquid crystal display comprising:
a liquid crystal screen;
a stand for supporting the liquid crystal screen;
a rotating device connected to the stand and a back side of the liquid crystal screen at an intersection point formed by an angle dividing line of a lower left corner of a plane of the screen and a line of an angle of 135 degrees elevated from a geometrical center of the screen, for allowing the liquid crystal screen to be freely rotated upwardly or downwardly and to be rotated freely on a plane parallel to the plane of the screen.

13. The liquid crystal display of claim 12, further comprising a positioning device, which includes a positioning hole installed at the stand; and a positioning portion formed on the back side of the liquid crystal screen, for being engaged with the positioning hole as the screen is in a predetermined condition, for rotating the screen, the positioning portion is separated from the positioning hole by tilting the screen.

14. A rotating device of a liquid crystal display connected to a stand and a back side of the liquid crystal screen at an intersection point formed by an angle dividing line at a lower right corner of a plane of the screen and a line of an angle of 45 degrees elevated from a geometrical center of the screen, for allowing the screen to be freely rotated upwardly or downwardly and to be rotated freely on a plane parallel to the plane of the screen.

15. The rotating device of claim 14, further comprising a positioning device, which includes a positioning hole installed at the stand; and a positioning portion formed on the back side of the liquid crystal screen, for being engaged with the positioning hole as the screen is in a predetermined condition, for rotating the screen, the positioning portion is separated from the positioning hole by tilting the screen.

16. A rotary device of a liquid crystal display connected to a stand and a back side of the liquid crystal screen at an intersection point formed by an angle dividing line at a lower left corner of a plane of the screen and a line of an angle of 135 degrees elevated from a geometrical center of the screen, for allowing the screen to be freely rotated upwardly or downwardly and to be rotated freely on a plane parallel to the plane of the screen.

17. The rotating device of claim 16, further comprising a positioning device, which includes a positioning hole installed at the stand; and a positioning portion formed on the back side of the liquid crystal screen, for being engaged with the positioning hole as the screen is in a predetermined condition, for rotating the screen, the positioning portion is separated from the positioning hole by tilting the screen.
